(19) United States
(12) Patent Application Publication
(10) Pub. No.: US 2014/0219200 A1
(43) Pub. Date: Aug. 7, 2014

(54) METHOD FOR CREATING BEARER AND APPARATUS

(71) Applicant: Huawei Technologies Co., Ltd., Shenzhen (CN)

(72) Inventors: Xiaoying Xu, Shanghai (CN); Dong Chen, Shanghai (CN); Zheng Zhou, Beijing (CN)

(73) Assignee: Huawei Technologies Co., Ltd., Shenzhen (CN)

(21) Appl. No.: 14/220,342

(22) Filed: Mar. 20, 2014

Related U.S. Application Data
(63) Continuation of application No. PCT/CN2012/081794, filed on Sep. 22, 2012.

(30) Foreign Application Priority Data
Sep. 22, 2011 (CN) 201110284170.3

(51) Int. Cl. H04W 72/04; H04W 76/02

(52) U.S. Cl. CPC H04W 72/0433; H04W 76/02; H04W 76/021
USPC 370/329

(57) ABSTRACT

The present invention discloses a method for creating bearer and apparatus. The method includes: receiving a bearer creation request message sent from a home base station (HNB) or a home base station gateway (HNB GW) and used to request creation of a bearer; and according to the bearer creation request message, instructing the one of the HNB and the HNB GW to create a bearer with a local gateway (LGW). The method for creating bearer and apparatus can implement creation of a bearer between the one of the HNB and the HNB GW and the LGW, and prevent the user equipment (UE) from generating signaling exchanged with a core network in some scenarios, thereby saving signaling overhead and improving user experience.

### CROSS-REFERENCE TO RELATED APPLICATIONS

This application is a continuation of International Application No. PCT/CN2012/081794, filed on Sep. 22, 2012, which claims priority to Chinese Patent Application No. 2011102841700.3, filed on Sep. 22, 2011, both of which are hereby incorporated by reference in their entireties.

### TECHNICAL FIELD

The present invention relates to the communications field, and in particular, to a method for creating bearer and apparatus in the communications field.

### BACKGROUND

A home base station (Home NodeB, “HNB” for short) may be used to expand coverage of a mobile network and provide more services that are well targeted. The HNB may belong to no home or enterprise, and may be connected to a network of a mobile operator through a broadband connection. A terminal authorized to access the HNB may use an HNB of a third-generation mobile communications technology (3rd-Generation, “3G” for short) or a long term evolution (Long Term Evolution, “LTE” for short) system to access the network of the mobile operator to obtain a service.

The HNB may also be used to deploy a local network at an enterprise or home. In this way, a UE that accesses the HNB can access the local network deployed by the home base station, and user data does not need to flow through a core network of the operator. In an HNB system architecture of release 10, a local gateway (Local GateWay, “LGW” for short) is integrated with the HNB, and the LGW and the HNB have the same address. The HNB that supports local IP (Internet Protocol) access (Local IP Access, “LIPA” for short) can report an IP address of the LGW to a serving GPRS support node (Serving GPRS Support Node, “SGSN” for short, where a general packet radio service (General Packet Radio Service) is abbreviated as “GPRS”) by using a user equipment (User Equipment, “UE” for short) initialization message, and provide a Gi/SGi interface for the LIPA so that an internal user plane path between the LGW and the HNB can be correlated by using a relevant ID (identifier).

The LGW integrated with the HNB supports the internal user plane path directed to the HNB, supports deactivation of an LIPA packet data network (Packet Data Network, “PDN” for short) connection, supports sending of a first packet of an idle UE to an SGSN or a security gateway (Security Gateway, “SGW” for short), and buffers subsequent downlink packets.

However, an HNB system currently cannot implement creation of a bearer between the LGW and a radio access network (Radio Access Network, “RAN” for short) node including the HNB or a home base station gateway (Home NodeB GateWay, “HNB GW” for short).

### SUMMARY

Multiple aspects of the present invention provide a method for creating bearer and apparatus to implement creation of a bearer between an HNB or an HNB GW and an LGW.

One aspect of the present invention provides a method for creating bearer. The method includes: receiving a bearer creation request message sent from a home base station (HNB) or a home base station gateway (HNB GW) and used to request creation of a bearer; and according to the bearer creation request message, instructing the one of the HNB and the HNB GW to create a bearer with a local gateway (LGW).

Another aspect of the present invention provides a method for creating bearer. The method includes: sending a bearer creation request message to a serving GPRS support node (SGSN), where the bearer creation request message is used to request creation of a bearer; and receiving a bearer creation indication message sent from the SGSN according to the bearer creation request message, and creating a bearer with a local gateway (LGW) according to the bearer creation indication message, where the bearer creation indication message is used to indicate creation of a bearer between an HNB or an HNB GW and the LGW.

Another aspect of the present invention provides a serving GPRS support node (SGSN). The SGSN includes: a receiving module, configured to receive a bearer creation request message sent from a home base station (HNB) or a home base station gateway (HNB GW) and used to request creation of a bearer; and an instructing module, configured to: according to the bearer creation request message received by the receiving module, instruct the one of the HNB and the HNB GW to create a bearer with a local gateway (LGW).

Another aspect of the present invention provides a home base station (HNB). The HNB includes: a sending module, configured to send a bearer creation request message to a serving GPRS support node (SGSN), where the bearer creation request message is used to request creation of a bearer; and a processing module, configured to receive a bearer creation indication message sent from the SGSN according to the bearer creation request message sent from the sending module, and create a bearer with a local gateway (LGW) according to the bearer creation indication message, where the bearer creation indication message is used to indicate creation of a bearer between the HNB and the LGW.

Another aspect of the present invention provides a home base station gateway (HNB GW). The HNB GW includes: a sending module, configured to send a bearer creation request message to a serving GPRS support node (SGSN), where the bearer creation request message is used to request creation of a bearer; and a processing module, configured to receive a bearer creation indication message sent from the SGSN according to the bearer creation request message sent from the sending module, and create a bearer with a local gateway (LGW) according to the bearer creation indication message, where the bearer creation indication message is used to indicate creation of a bearer between the HNB GW or the LGW.

Based on the foregoing technical solutions, the method for creating bearer and apparatus in the embodiments of the present invention can implement creation of a bearer between an HNB or an HNB GW and an LGW, and prevent a user equipment (UE) from generating signaling exchanged with a core network in some scenarios, thereby saving signaling overhead and improving user experience.

### BRIEF DESCRIPTION OF THE DRAWINGS

To describe the technical solutions in the embodiments of the present invention more clearly, the following briefly introduces the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is a schematic flowchart of a method for creating bearer according to an embodiment of the present invention;

FIG. 2 is a schematic architectural diagram of an HNB system according to an embodiment of the present invention;

FIG. 3 is another schematic flowchart of a method for creating bearer according to an embodiment of the present invention;

FIG. 4 is another schematic flowchart of a method for creating bearer according to an embodiment of the present invention;

FIG. 5 is another schematic architectural diagram of an HNB system according to an embodiment of the present invention;

FIG. 6 is another schematic flowchart of a method for creating bearer according to an embodiment of the present invention;

FIG. 7 is another schematic flowchart of a method for creating bearer according to an embodiment of the present invention;

FIG. 8 is another schematic flowchart of a method for creating bearer according to an embodiment of the present invention;

FIG. 9 is a schematic flowchart of a method for creating bearer according to another embodiment of the present invention;

FIG. 10 is another schematic flowchart of a method for creating bearer according to another embodiment of the present invention;

FIG. 11 is another schematic flowchart of a method for creating bearer according to another embodiment of the present invention;

FIG. 12 is another schematic flowchart of a method for creating bearer according to another embodiment of the present invention;

FIG. 13 is another schematic flowchart of a method for creating bearer according to another embodiment of the present invention;

FIG. 14 is a schematic flowchart of a method for creating bearer according to another embodiment of the present invention;

FIG. 15 is a schematic block diagram of an SGSN according to an embodiment of the present invention;

FIG. 16 is a schematic block diagram of an instructing module according to an embodiment of the present invention;

FIG. 17 is another schematic block diagram of an SGSN according to an embodiment of the present invention;

FIG. 18 is another schematic block diagram of an instructing module according to an embodiment of the present invention;

FIG. 19 is another schematic block diagram of an SGSN according to an embodiment of the present invention;

FIG. 20 is another schematic block diagram of an SGSN according to an embodiment of the present invention;

FIG. 21 is a schematic block diagram of an HNB according to an embodiment of the present invention;

FIG. 22 is a schematic block diagram of a processing module according to an embodiment of the present invention;

FIG. 23 is another schematic block diagram of a processing module according to an embodiment of the present invention;

FIG. 24 is a schematic block diagram of an HNB GW according to an embodiment of the present invention;

FIG. 25 is a schematic block diagram of a processing module according to an embodiment of the present invention; and

FIG. 26 is another schematic block diagram of a processing module according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

Understandably, the technical solutions of the present invention are applicable to various communications systems, for example, a global system for mobile communications (Global System for Mobile communications, “GSM” for short) system, a code division multiple access (Code Division Multiple Access, “CDMA” for short) system, a wideband code division multiple access (Wideband Code Division Multiple Access, “WCDMA” for short) system, a general packet radio service (General Packet Radio Service, “GPRS” for short) system, a long term evolution (Long Term Evolution, “LTE” for short) system, an LTE frequency division duplex (Frequency Division Duplex, “FDD” for short) system, an LTE time division duplex (Time Division Duplex, “TDD” for short) system, a universal mobile telecommunications system (Universal Mobile Telecommunication System, “UMTS” for short), and so on.

Also understandably, a user equipment (User Equipment, “UE” for short) in the embodiments of the present invention is also referred to as a terminal (Terminal), a mobile station (Mobile Station, “MS” for short), a mobile terminal (Mobile Terminal), and so on. The user equipment may communicate with one or more core networks through a radio access network (Radio Access Network, “RAN” for short). For example, the user equipment may be a mobile phone (or called a “cellular” phone), or a computer equipped with a mobile terminal. For example, the user equipment may also be a mobile apparatus that is portable, pocket-sized, handheld, built in a computer, or mounted on a vehicle, which exchanges voice and/or data with the radio access network.

In the embodiments of the present invention, a base station may be a base transceiver station (Base Transceiver Station, “BTS” for short) in a GSM or CDMA system, or a base station (NodeB, “NB” for short) in a WCDMA system, or an evolved base station (Evolved Node B, “ENB or e-NodeB” for short) in an LTE system, which is not limited in the present invention. For ease of description, in the following embodiments, a home base station (HNB) and a user equipment (UE) are used as examples.

In addition, the terms “system” and “network” in this document are often exchangeable herein. The term “and/or” herein denotes only an association relationship between associated objects, and represents that three possible relationships may exist. For example, “A and/or B” may represent the following three cases: A exists alone, both A and B exist, and B exists alone. In addition, the symbol “/” in this document generally represents that associated objects before and after the symbol are in an “or” relationship.

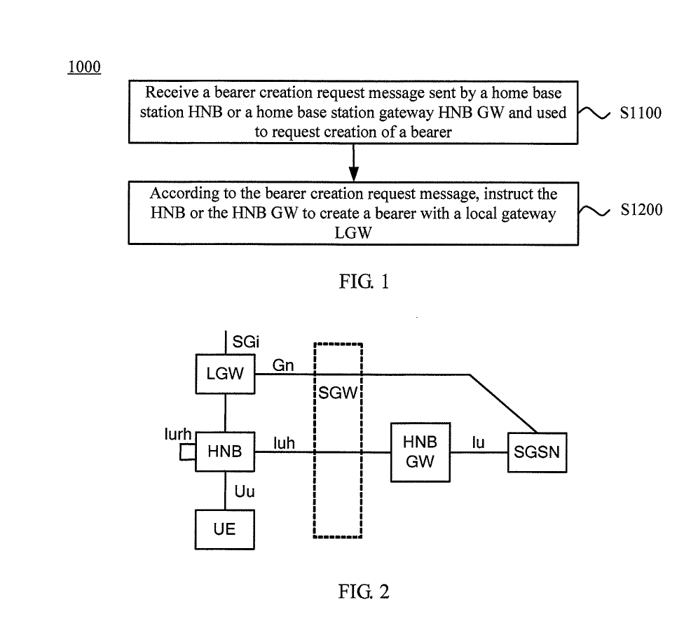

FIG. 1 shows a schematic flowchart of a method for creating bearer 1000 according to an embodiment of the present invention. As shown in FIG. 1, the method includes the following steps.

S1100. Receive a bearer creation request message sent from a home base station (HNB) or a home base station gateway (HNB GW) and used to request creation of a bearer.

S1200. According to the bearer creation request message, instruct the one of the HNB and the HNB GW to create a bearer with a local gateway (LGW).

To implement creation of the bearer between the RAN node and the LGW, an SGSN may receive the bearer creation request message sent from the one of the HNB and the HNB GW, where the bearer creation request message is used to request creation of the bearer between the one of the HNB and the HNB GW and the LGW. According to the bearer creation request message, the SGSN instructs the one of the HNB and the HNB GW to create a bearer with the local gateway (LGW), thereby implementing creation of the bearer between the one of the HNB and the HNB GW and the LGW.

Therefore, the method for creating bearer in the embodiment of the present invention can implement creation of a bearer between an HNB or an HNB GW and an LGW, and prevent a user equipment (UE) from generating signaling exchanged with a core network in some scenarios, thereby saving signaling overhead and improving user experience.

The following describes a method for creating bearer according to an embodiment of the present invention in detail from a perspective of an SGSN with reference to FIG. 2 to FIG. 8.

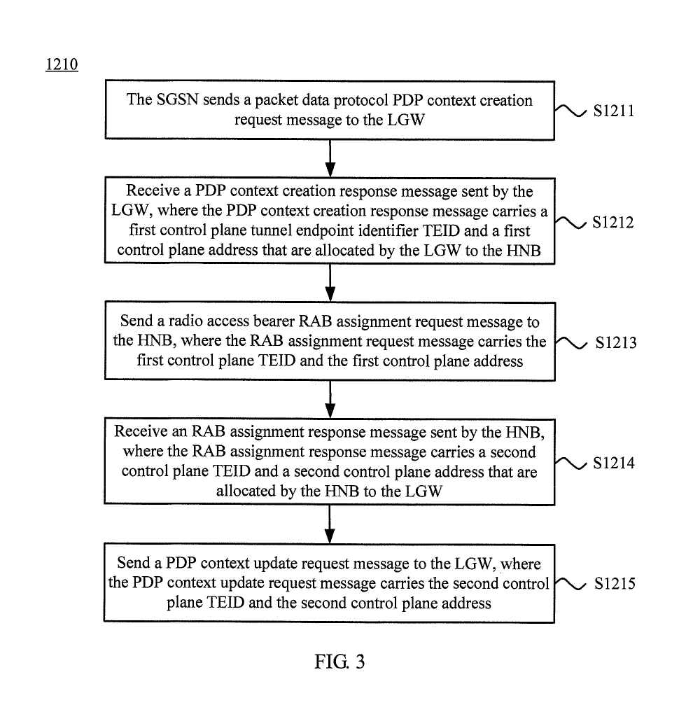

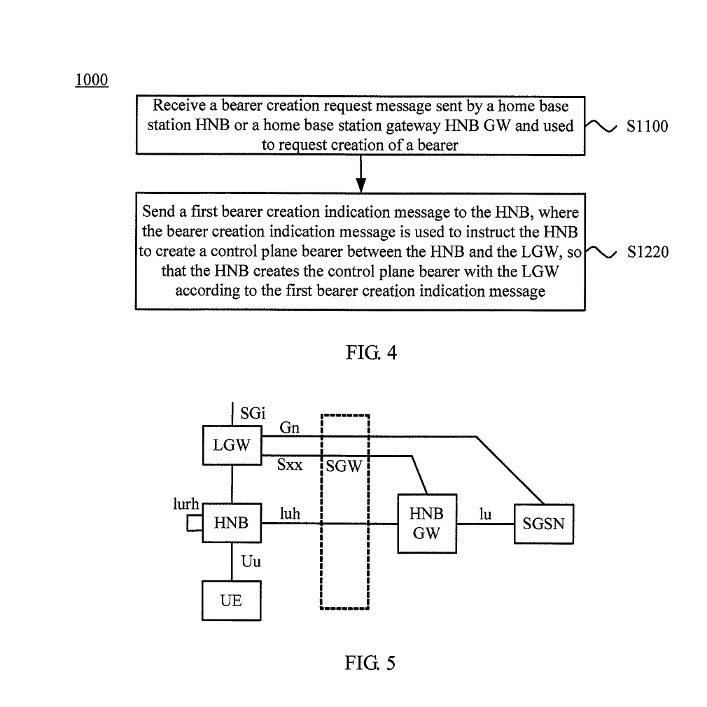

FIG. 2 shows a schematic architectural diagram of an HNB system according to an embodiment of the present invention. As shown in FIG. 2, an LGW is connected to an HNB GW indirectly through an HNB, and the HNB is connected to the HNB GW through an luh interface. The following describes a method for creating bearer according to an embodiment of the present invention with reference to FIG. 3 and FIG. 4 in a case where the HNB system has an architecture shown in FIG. 2.

In the embodiment of the present invention, optionally, the bearer creation request message includes at least one of an identifier of a local network on where the LGW is located, an address list of the LGW in a core network, and a first request message used to request creation of a control plane bearer between the HNB and the LGW. Optionally, the bearer creation request message is a radio access network application part (Radio Access Network Application Part, “RANAP” for short) message.

For example, the RANAP message includes an identifier LHN-ID of a local network on where the LGW is located; and the RANAP message includes an address list of the LGW in a core network, that is, an LGW@CN address list, where the LGW@CN address list may include only one address. According to the L-GW@CN address list and/or the LHN-ID included in the bearer creation request message, the SGSN may decide whether to create a local control plane bearer.

For example, the RANAP message may further carry explicit indication information. For example, the RANAP message may include a first request message used to request creation of a control plane bearer between the HNB and the LGW. According to the first request message, the SGSN may decide whether to create the local control plane bearer. Understandably, according to at least one of the received LGW@CN address list, the LHN-ID, and the explicit first request message that requests creation of the control plane bearer, the SGSN may decide whether to create the control plane bearer between the HNB and the LGW.

As shown in FIG. 3, in the method for creating bearer 1000 according to an embodiment of the present invention, the method 1210 for the SGSN to instruct the one of the HNB and the HNB GW to create a bearer with the local gateway (LGW) may be described as follows:

S1211. The SGSN sends a packet data protocol (Packet Data Protocol, “PDP” for short) context creation request message to the LGW.

S1212. The SGSN receives a PDP context creation response message sent from the LGW, where the PDP context creation response message carries a first control plane tunnel endpoint identifier (Tunnel Endpoint Identifier, “TEID” for short) and a first control plane address that are allocated by the LGW to the HNB.

S1213. The SGSN sends a radio access bearer (Radio Access Bearer, “RAB” for short) assignment request message to the HNB, where the RAB assignment request message carries the first control plane TEID and the first control plane address.

S1214. The SGSN receives an RA33 assignment response message sent from the HNB, where the RAB assignment response message carries a second control plane TEID and a second control plane address that are allocated by the HNB to the LGW.

S1215. The SGSN sends a PDP context update request message to the LGW, where the PDP context update request message carries the second control plane TEID and the second control plane address.

In S1211, optionally, the PDP context creation request message includes a first request message, where the first request message is used to request creation of a control plane bearer between the HNB and the LGW. In this way, the LGW can allocate a control plane address and a control plane TEID to the HNB according to the first request message.

In S1212, optionally, the PDP context creation response message received by the SGSN may include at least one of an address LGW@CN of the local gateway (LGW) in a core network and an address LGW@LN of the LGW in a local network, and include a control plane TEID allocated by the LGW to the HNB. Understandably, the LGW@LN address may be simultaneously used as a local address of both a user plane and a control plane, that is, the first control plane address may be the same as a user plane address allocated by the LGW to the HNB.

In S1213, optionally, the RAB assignment request message includes a first request message, where the first request message is used to request creation of a control plane bearer between the HNB and the LGW. In this way, the HNB can allocate a control plane address and a control plane TEID to the LGW according to the first request message.

In S1214, the second control plane address allocated by the HNB to the LGW may be a local address of the HNB, and the second control plane address may also be the same as the user plane address allocated by the HNB to the LGW, that is, the HNB control plane address may be shared with the HNB user plane address.

In S1215, the SGSN sends to the LGW the second control plane TEID and the second control plane address allocated by the HNB to the LGW, thereby completing creation of the control plane bearer between the HNB and the LGW.

Therefore, the method for creating bearer in the embodiment of the present invention can implement creation of a control plane bearer between an HNB and an LGW, and prevent a user equipment (UE) from generating signaling exchanged with a core network in some scenarios, thereby saving signaling overhead and improving user experience.

In the embodiment of the present invention, the local control plane bearer may be not created in an LIPA bearer creation process. Instead, when deciding to create the LIPA bearer, the SGSN instructs the HNB and the LGW to create a bearer, which is described below with reference to FIG. 4. Therefore, the control plane bearer between the HNB and the LGW may be created at the time of creating an LIPA bearer, or created at the time of switching the LIPA bearer.

As shown in FIG. 4, 51200 in the method for creating bearer 1000 according to an embodiment of the present invention may be described as follows:

S1220. The SGSN sends a first bearer creation indication message to the HNB, where the first bearer creation indication message is used to instruct the HNB to create a control plane bearer between the HNB and the LGW, so that the HNB creates the control plane bearer with the LGW according to the first bearer creation indication message.

That is, after the SGSN receives the bearer creation request message sent from the HNB, the SGSN sends a first bearer creation indication message to the HNB, where the first bearer creation indication message is used to instruct the HNB to create a control plane bearer between the HNB and the LGW. In this way, according to the first bearer creation indication message, the HNB and the LGW can exchange the control plane address and the control plane TEID allocated to each other, thereby implementing creation of the control plane bearer between the HNB and the LGW.

In S1220, optionally, the first bearer creation indication message is an RAB assignment request message sent from the SGSN to the HNB.

Optionally, the first bearer creation indication message includes at least one of a control plane address of the LGW in the local network and first indication information used to instruct the HNB to initiate creation of the control plane bearer. The control plane address of the LGW in the local network may be a control plane address allocated by the LGW to the HNB, for example, an LGW@LN address.

Therefore, the method for creating bearer in the embodiment of the present invention can implement creation of a control plane bearer between an HNB and an LGW, and prevent a user equipment (UE) from generating signaling exchanged with a core network in some scenarios, thereby saving signaling overhead and improving user experience.

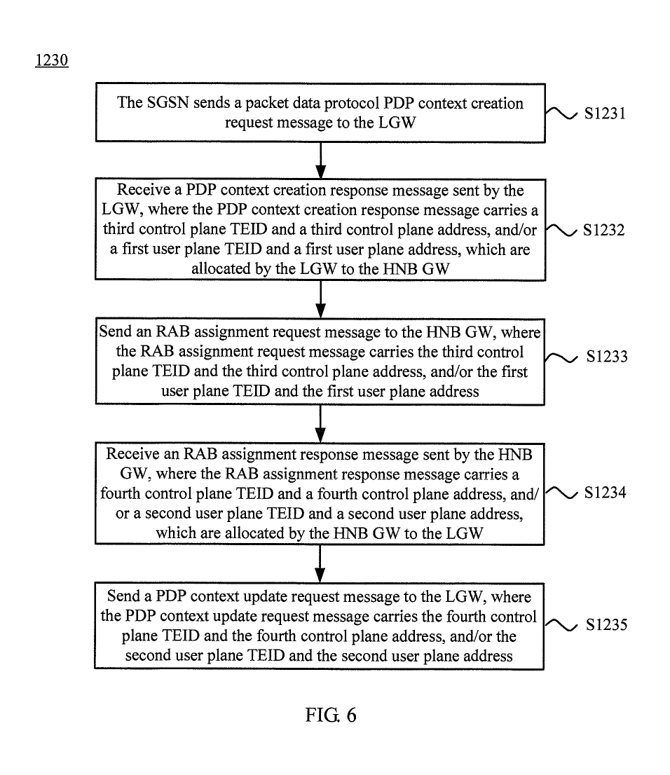

FIG. 5 shows another schematic architectural diagram of an HNB system according to an embodiment of the present invention. As shown in FIG. 5, an LGW is connected to an HNB GW directly through an Sxx interface. The following describes a method for creating bearer according to an embodiment of the present invention with reference to FIG. 6 to FIG. 8 in a case where the HNB system has an architecture shown in FIG. 5.

In the embodiment of the present invention, optionally, the bearer creation request message includes at least one of a control plane address of the HNB GW in a core network, a user plane address of the HNB GW in the core network, and a second request message used to request creation of at least one control plane bearer and user plane bearer between the HNB GW and the LGW. Optionally, the bearer creation request message is an RANAP message.

That is, the SGSN may decide creation of a local control plane bearer according to a decision of creating an LIPA bearer. The SGSN may decide creation of the local control plane bearer according to the decision of creating an LIPA bearer and a CN domain control plane address received from the HNB GW, or decide creation of the local control plane bearer according to the decision of creating an LIPA bearer and explicit a second request message.

As shown in FIG. 6, in the method for creating bearer 1000 according to an embodiment of the present invention, the method 1230 for the SGSN to instruct the one of the HNB and the HNB GW to create a bearer with the local gateway (LGW) may be described as follows:

S1231. The SGSN sends a packet data protocol (PDP) context creation request message to the LGW.

S1232. The SGSN receives a PDP context creation response message sent from the LGW, where the PDP context creation response message carries a third control plane TEID and a third control plane address, and/or a first user plane TEID and a first user plane address, which are allocated by the LGW to the HNB GW.

S1233. The SGSN sends an RAB assignment request message to the HNB GW, where the RAB assignment request message carries the third control plane TEID and the third control plane address, and/or the first user plane TEID and the first user plane address.

S1234. The SGSN receives an RAB assignment response message sent from the HNB GW, where the RAB assignment response message carries a fourth control plane TEID and a fourth control plane address, and/or a second user plane TEID and a second user plane address, which are allocated by the HNB GW to the LGW.

S1235. The SGSN sends a PDP context update request message to the LGW, where the PDP context update request message carries the fourth control plane TEID and the fourth control plane address, and/or the second user plane TEID and the second user plane address.

In S1231, optionally, the PDP context creation request message includes a second request message, where the second request message is used to request creation of a control plane bearer between the HNB GW and the LGW. In this way, the LGW can allocate a control plane address and a control plane TEID, and/or a user plane address and a user plane TEID, to the HNB GW according to the second request message.

In S1232, the PDP context creation response message carries a third control plane TEID and a third control plane address, and/or a first user plane TEID and a first user plane address, which are allocated by the LGW to the HNB GW. That is, the PDP context creation response message includes the third control plane TEID and the third control plane address, or includes the first user plane TEID and the first user plane address, or includes the third control plane TEID, the third control plane address, the first user plane TEID, and the first user plane address.

Optionally, the PDP context creation response message received by the SGSN may include at least one of the third control plane TEID and the first user plane TEID that are allocated by the LGW to the HNB GW, and include an address LGW@CN of the local gateway (LGW) in a core network. Understandably, the LGW@CN address may be simultaneously used as a local address of both a user plane and a control plane, that is, the third control plane address may be the same as the first user plane address allocated by the LGW to the HNB GW.

In S1233, optionally, the RAB assignment request message includes a second request message, so that the HNB GW can allocate a control plane address and a control plane TEID, and/or a user plane address and a user plane TEID, to the LGW according to the second request message.

In S1234, the RAB assignment response message carries a fourth control plane TEID and a fourth control plane address, and/or a second user plane TEID and a second user plane address, which are allocated by the HNB GW to the LGW.

In S1235, the SGSN sends to the LGW the control plane and/or user plane address and the TEID allocated by the HNB GW to the LGW, thereby completing creation of the at least one control plane bearer and user plane bearer between the HNB GW and the LGW.

In the embodiment of the present invention, optionally, at least one of the PDP context creation request message and the RAB assignment request message include a second request message, where the second request message is used to request creation of at least one control plane bearer and user plane bearer between the HNB GW and the LGW.

Therefore, the method for creating bearer in the embodiment of the present invention can implement creation of a control plane bearer and/or a user plane bearer between an HNB GW and an LGW, and prevent a user equipment (UE) from generating signaling exchanged with a core network in some scenarios, thereby saving signaling overhead and improving user experience.

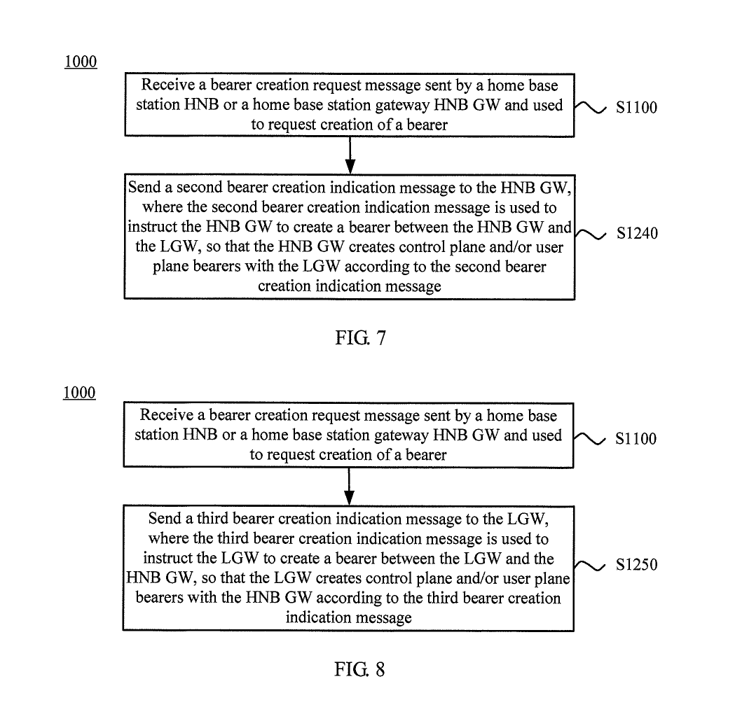

FIG. 7 shows a schematic flowchart of a method for creating bearer according to an embodiment of the present invention. As shown in FIG. 7, 51200 in the method 1000 may be described as follows:

S1240. The SGSN sends a second bearer creation indication message to the HNB GW, where the second bearer creation indication message is used to instruct the HNB GW to create a bearer between the HNB GW and the LGW, so that the HNB GW creates at least one control plane bearer and user plane bearer with the LGW according to the second bearer creation indication message.

That is, after the SGSN receives the bearer creation request message sent from the HNB GW, the SGSN sends a second bearer creation indication message to the HNB GW according to the bearer creation request message, where the second bearer creation indication message is used to instruct the HNB GW to create at least one control plane bearer and user plane bearer between the HNB GW and the LGW by using an Sxx interface. In this way, according to the second bearer creation indication message, the HNB GW can exchange the control plane address and the control plane TEID and/or the user plane address and the user plane TEID allocated to the opposite party with the LGW, thereby implementing creation of the at least one control plane bearer and user plane bearer between the HNB GW and the LGW.

In S1240, optionally, the second bearer creation indication message is an RAB assignment request message sent from the SGSN to the HNB.

In the embodiment of the present invention, optionally, the second bearer creation indication message includes at least one of local IP access LIPA bearer information, a control plane address of the LGW in a core network, a user plane address of the LGW in the core network, and second indication information used to instruct the HNB GW to initiate creation of the at least one control plane bearer and user plane bearer.

In the embodiment of the present invention, the HNB GW may initiate a at least one control plane bearer and user plane bearer creation procedure to the LGW according to an address carried in the message or previously stored address information after receiving a TNL update request or response or relocation completion; the HNB GW may also initiate a at least one control plane bearer and user plane bearer creation procedure to the LGW according to an address indicated in a switching request after receiving the switching request or a switching request acknowledgement; and the HNB GW may also initiate a at least one control plane bearer and user plane bearer creation procedure to the LGW after receiving an RAB assignment request message or an RAB assignment response message.

Therefore, in the method for creating bearer in the embodiment of the present invention, an SGSN instructs an HNB GW to initiate bearer creation to an LGW directly, which can implement creation of a control plane bearer and/or a user plane bearer between the HNB GW and the LGW, and prevent a user equipment (UE) from generating signaling exchanged with a core network in some scenarios, thereby saving signaling overhead is saved and improving user experience.

As shown in FIG. 8, in the method for creating bearer 1000 according to an embodiment of the present invention, the method S1200 for the SGSN to instruct the one of the HNB and the HNB GW to create a bearer with the local gateway (LGW) may be described as follows:

S1250. The SGSN sends a third bearer creation indication message to the LGW, where the third bearer creation indication message is used to instruct the LGW to create a bearer between the LGW and the HNB GW, so that the LGW creates at least one control plane bearer and user plane bearer with the HNB GW according to the third bearer creation indication message.

That is, after the SGSN receives the bearer creation request message sent from the HNB GW, the SGSN sends a third bearer creation indication message to the LGW according to the bearer creation request message, where the third bearer creation indication message is used to instruct the LGW to create at least one control plane bearer and user plane bearer between the LGW and the HNB GW by using an Sxx interface. In this way, according to the third bearer creation indication message, the LGW can exchange the control plane address and the control plane TEID and/or the user plane address and the user plane TEID allocated to the opposite party with the HNB GW, thereby creating the at least one control plane bearer and user plane bearer between the LGW and the HNB GW.

In S1240, optionally, the second bearer creation indication message is an RAB assignment request message sent from the SGSN to the HNB.

In the embodiment of the present invention, optionally, the third bearer creation indication message includes at least one of a control plane address of the HNB GW in a core network, a user plane address of the HNB GW in a core network, and third indication information used to instruct the LGW to initiate creation of at least one control plane bearer and user plane bearer.

Therefore, in the method for creating bearer in the embodiment of the present invention, an SGSN instructs an LGW to initiate bearer creation to an HNB GW directly, which can implement creation of a control plane bearer and/or a user plane bearer between the HNB GW and the LGW, and prevent a user equipment (UE) from generating signaling exchanged with a core network in some scenarios, thereby saving signaling overhead and improving user experience.

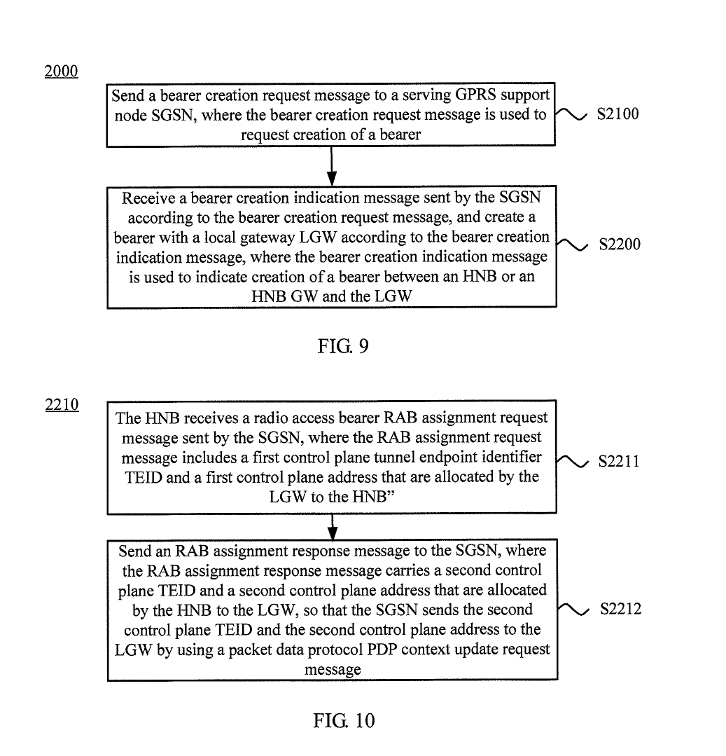

The above has described the method for creating bearer according to an embodiment of the present invention in detail from a perspective of an SGSN with reference to FIG. 1 to FIG. 8. The following describes a method for creating bearer according to an embodiment of the present invention in detail from a perspective of an HNB or an HNB GW with reference to FIG. 9 to FIG. 13.

As shown in FIG. 9, the method for creating bearer 2000 according to an embodiment of the present invention may be described as follows:

S2100. Send a bearer creation request message to a serving GPRS support node (SGSN), where the bearer creation request message is used to request creation of a bearer.

S2200. Receive a bearer creation indication message sent from the SGSN according to the bearer creation request message, and create a bearer with a local gateway (LGW) according to the bearer creation indication message, where the bearer creation indication message is used to indicate creation of a bearer between an HNB or an HNB GW and the LGW.

To implement creation of the bearer between the one of the HNB and the HNB GW and the LGW, the one of the HNB and the HNB GW may send a bearer creation request message to the SGSN, where the bearer creation request message is used to request creation of the bearer between the one of the HNB and the HNB GW and the LGW. The one of the HNB and the HNB GW receives the bearer creation indication message sent from the SGSN according to the bearer creation request message, and therefore, the one of the HNB and the HNB GW can create a bearer with the local gateway (LGW) according to the bearer creation indication message, thereby implementing creation of the bearer between the one of the HNB and the HNB GW and the LGW.

Therefore, the method for creating bearer in the embodiment of the present invention can implement creation of a bearer between an HNB or an HNB GW and an LGW, and prevent a user equipment (UE) from generating signaling exchanged with a core network in some scenarios, thereby saving signaling overhead and improving user experience.

In S2100, optionally, the bearer creation request message is an RANAP message. In an architecture without a direct interface between the HNB GW and the LGW, as shown in FIG. 2, optionally, the bearer creation request message includes at least one of an identifier of a local network on where the LGW is located, an address list of the LGW in a core network, and a first request message used to request creation of a control plane bearer between the HNB and the LGW.

In an architecture with a direct interface between the HNB GW and the LGW, as shown in FIG. 5, optionally, the bearer creation request message includes at least one of a control plane address of the HNB GW in a core network, a user plane address of the HNB GW in the core network, and a second request message used to request creation of at least one control plane bearer and user plane bearer between the HNB GW and the LGW.

In S2200, the method 2210 for receiving a bearer creation indication message sent from the SGSN according to the bearer creation request message and creating a bearer with a local gateway (LGW) according to the bearer creation indication message may be described as follows:

S2211. The HNB receives a radio access bearer (RAB) assignment request message sent from the SGSN, where the RAB assignment request message includes a first control plane tunnel endpoint identifier (TEID) and a first control plane address that are allocated by the LGW to the HNB.

S2212. The HNB sends an RAB assignment response message to the SGSN, where the RAB assignment response message carries a second control plane TEID and a second control plane address that are allocated by the HNB to the LGW, so that the SGSN sends the second control plane TEID and the second control plane address to the LGW by using a packet data protocol (PDP) context update request message.

In S2211, the bearer creation indication message is an RAB assignment request message. Optionally, the RAB assignment request message may further include information used to instruct or request the HNB to initiate creation of a control plane bearer.

Therefore, the method for creating bearer in the embodiment of the present invention can implement creation of a control plane bearer between an HNB and an LGW, and prevent a user equipment (UE) from generating signaling exchanged with a core network in some scenarios, thereby saving signaling overhead and improving user experience.

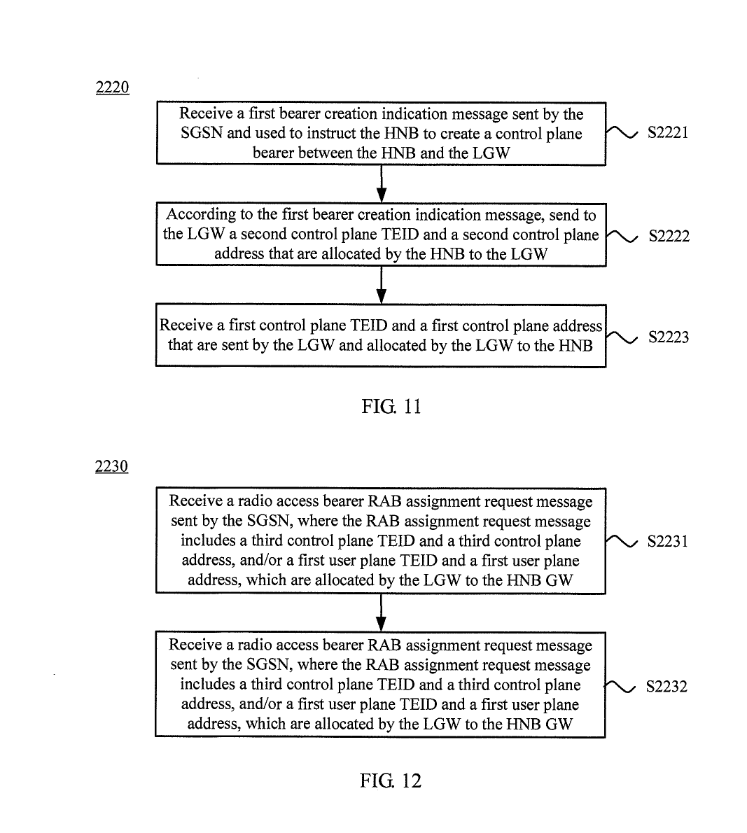

In the embodiment of the present invention, as shown in FIG. 11, in S2200, the method 2220 for receiving a bearer creation indication message sent from the SGSN according to the bearer creation request message and creating a bearer with a local gateway (LGW) according to the bearer creation indication message may be described as follows:

S2221. An HNB receives a first bearer creation indication message sent from the SGSN and used to instruct the HNB to create a control plane bearer between the HNB and the LGW.

S2222. According to the first bearer creation indication message, the HNB sends to the LGW a second control plane TEID and a second control plane address that are allocated by the HNB to the LGW.

S2223. The HNB receives a first control plane TEID and a first control plane address that are sent from the LGW and allocated by the LGW to the HNB.

In the embodiment of the present invention, optionally, the first bearer creation indication message includes at least one of a control plane address of the LGW in the local network and first indication information used to instruct the HNB to initiate creation of the control plane bearer.

Therefore, the method for creating bearer in the embodiment of the present invention can implement creation of a control plane bearer between an HNB and an LGW, and prevent a user equipment (UE) from generating signaling exchanged with a core network in some scenarios, thereby saving signaling overhead and improving user experience.

In an architecture with a direct interface between the HNB GW and the LGW, as shown in FIG. 12, in S2200, the method 2230 for receiving a bearer creation indication message sent from the SGSN according to the bearer creation request message and creating a bearer with a local gateway (LGW) according to the bearer creation indication message may be described as follows:

S2231. The HNB GW receives a radio access bearer (RAB) assignment request message sent from the SGSN, where the RAB assignment request message includes a third control plane TEID and a third control plane address, and/or a first user plane TEID and a first user plane address, which are allocated by the LGW to the HNB GW.

S2232. The HNB GW sends an RAB assignment response message to the SGSN, where the RAB assignment response message carries a fourth control plane TEID and a fourth control plane address, and/or a second user plane TEID and a second user plane address, which are allocated by the HNB GW to the LGW, so that the SGSN sends the fourth control plane TEID and the fourth control plane address, and/or the second user plane TEID and the second user plane address, to the LGW by using a packet data protocol (PDP) context update request message.

Optionally, the RAB assignment request message may further include information used to instruct or request the HNB GW to initiate creation of at least one control plane bearer and user plane bearer.

Therefore, the method for creating bearer in the embodiment of the present invention can implement creation of at least one control plane bearer and user plane bearer between an HNB GW and an LGW, and prevent a user equipment (UE) from generating signaling exchanged with a core network in some scenarios, thereby saving signaling overhead and improving user experience.

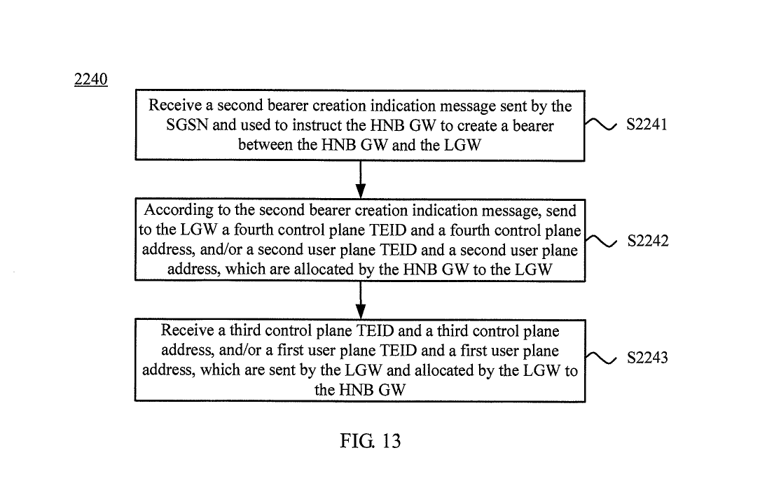

As shown in FIG. 13, in S2200, the method 2240 for receiving a bearer creation indication message sent from the SGSN according to the bearer creation request message and creating a bearer with a local gateway (LGW) according to the bearer creation indication message may be described as follows:

S2241. The HNB GW receives a second bearer creation indication message sent from the SGSN and used to instruct the HNB GW to create a bearer between the HNB GW and the LGW.

S2242. According to the second bearer creation indication message, the HNB GW sends to the LGW a fourth control plane TEID and a fourth control plane address, and/or a second user plane TEID and a second user plane address, which are allocated by the HNB GW to the LGW.

S2243. The HNB GW receives a third control plane TEID and a third control plane address, and/or a first user plane TEID and a first user plane address, which are sent from the LGW and allocated by the LGW to the HNB GW.

In the embodiment of the present invention, optionally, the second bearer creation indication message includes at least one of local IP access LIPA bearer information, a control plane address of the LGW in a core network, a user plane address of the LGW in the core network, and second indication information used to instruct the HNB GW to initiate creation of the at least one control plane bearer and user plane bearer.

Therefore, the method for creating bearer in the embodiment of the present invention can implement creation of at least one control plane bearer and user plane bearer between an HNB GW and an LGW, and prevent a user equipment (UE) from generating signaling exchanged with a core network in some scenarios, thereby saving signaling overhead and improving user experience.

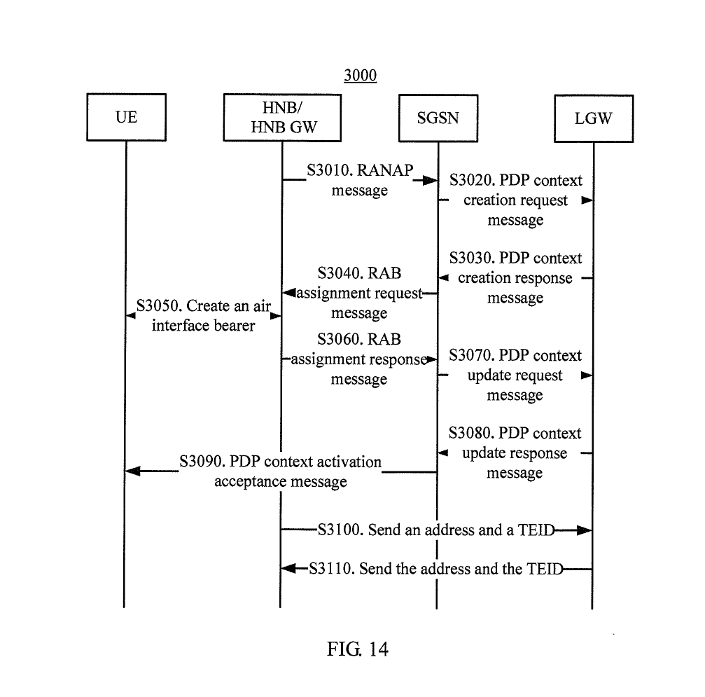

The following further describes a method for creating bearer 3000 according to an embodiment of the present invention with reference to FIG. 14. As shown in FIG. 14, the method 3000 is described as follows:

In S3010, an HNB or an HNB GW sends an RANAP message to an SGSN, where the RANAP message is used to request creation of a bearer between the one of the HNB and the HNB GW and an LGW; the RANAP message may include at least one of an identifier of a local network on where the LGW is located, an address list of the LGW in a core network, and a first request message used to request creation of a control plane bearer between the HNB and the LGW; and the RANAP message may also include at least one of a control plane address of the HNB GW in the core network, a user plane address of the HNB GW in the core network, and a second request message used to request creation of at least one control plane bearer and user plane bearer between the HNB GW and the LGW.

According to the RANAP message, the SGSN can determine whether to allow creation of a bearer between the one of the HNB and the HNB GW and the LGW. By using a PDP context creation request message (as mentioned in S3020), the SGSN may instruct the LGW to create at least one control plane bearer and user plane bearer with the HNB GW directly or indirectly, or instruct the LGW to create a control plane bearer with the HNB directly or indirectly; and the SGSN may also use an RAB assignment request message (as mentioned in S3040) to instruct the HNB to create a control plane bearer with the LGW directly or indirectly, or instruct the HNB GW to create at least one control plane bearer and user plane bearer with the LGW directly or indirectly. Direct creation of a bearer between the one of the HNB and the HNB GW and the LGW is shown in S3100 and S3110.

In S3020, the SGSN sends a PDP context creation request message to the LGW.

In S3030, the LGW sends a PDP context creation response message to the SGSN.

In S3040, the SGSN sends an RAB assignment request message to the one of the HNB and the HNB GW.

In S3050, the UE creates an air interface bearer with the HNB.

In S3060, the one of the HNB and the HNB GW sends an RAB assignment response message to the SGSN.

In S3070, the SGSN sends a PDP context update request message to the LGW.

In S3080, the LGW sends a PDP context update response message to the SGSN.

In S3090, the SGSN sends a PDP context activation acceptance message to the one of the HNB and the HNB GW.

In S3100, the one of the HNB and the HNB GW sends control plane and/or user plane addresses and a TEID to the LGW directly.

In S3110, the LGW sends the control plane and/or user plane addresses and the TEID to the one of the HNB and the HNB GW directly.

Understandably, the sequence number of each process does not represent order of implementation, and the order of implementing the processes depends on their functions and inherent logics, and shall not constitute any limitation on the implementation process of the embodiments of the present invention.

Therefore, the method for creating bearer in the embodiment of the present invention can implement creation of a bearer between an HNB or an HNB GW and an LGW, and prevent a user equipment (UE) from generating signaling exchanged with a core network in some scenarios, thereby saving signaling overhead and improving user experience.

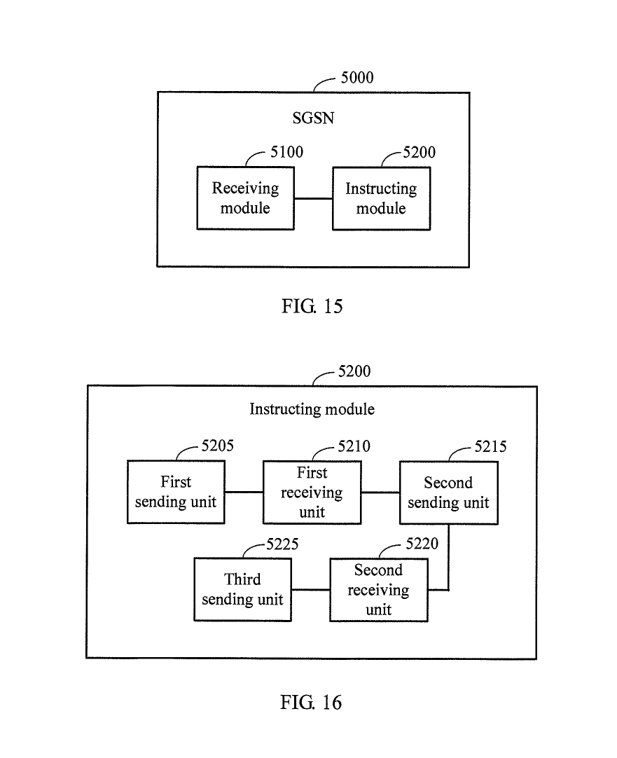

The above has described the method for creating bearer according to an embodiment of the present invention in detail with reference to FIG. 1 to FIG. 14. The following describes a bearer creating apparatus according to an embodiment of the present invention in detail with reference to FIG. 15 to FIG. 26. The apparatus includes an SGSN, an HNB, and an HNB GW for implementing the foregoing method.

FIG. 15 shows a schematic block diagram of an SGSN 5000 according to an embodiment of the present invention. As shown in FIG. 15, the serving GPRS support node (SGSN) 5000 may include a receiving module 5100 and an instructing module 5200.

The receiving module 5100 is configured to receive a bearer creation request message sent from a home base station (HNB) or a home base station gateway (HNB GW) and used to request creation of a bearer.

The instructing module 5200 is configured to: according to the bearer creation request message received by the receiving module 5100, instruct the one of the HNB and the HNB GW to create a bearer with a local gateway (LGW).

Therefore, the SGSN for creating a bearer in the embodiment of the present invention can implement creation of a bearer between an HNB or an HNB GW and an LGW, and prevent a user equipment (UE) from generating signaling exchanged with a core network in some scenarios, thereby saving signaling overhead and improving user experience.

In the embodiment of the present invention, optionally, the bearer creation request message received by the receiving module 5100 includes at least one of an identifier of a local network on where the LGW is located, an address list of the LGW in a core network, and a first request message used to request creation of a control plane bearer between the HNB and the LGW.

In the embodiment of the present invention, optionally, the bearer creation request message received by the receiving module 5100 includes at least one of a control plane address of the HNB GW in a core network, a control plane address of the HNB GW in the core network, and a second request message used to request creation of at least one control plane bearer and user plane bearer between the HNB GW and the LGW.

In the embodiment of the present invention, optionally, as shown in FIG. 16, the instructing module 5200 includes a first sending unit 5205, a first receiving unit 5210, a second sending unit 5215, a second receiving unit 5220, and a third sending unit 5225.

The first sending unit 5205 is configured to send a packet data protocol (PDP) context creation request message to the LGW.

The first receiving unit 5210 is configured to receive a PDP context creation response message sent from the LGW, where the PDP context creation response message carries a first control plane tunnel endpoint identifier (TEID) and a first control plane address that are allocated by the LGW to the HNB.

The second sending unit 5215 is configured to send a radio access bearer (RAB) assignment request message to the HNB, where the RAB assignment request message carries the first control plane TEID and the first control plane address.

The second receiving unit 5220 is configured to receive an RAB assignment response message sent from the HNB, where the RAB assignment response message carries a second control plane TEID and a second control plane address that are allocated by the HNB to the LGW.

The third sending unit 5225 is configured to send a PDP context update request message to the LGW, where the PDP context update request message carries the second control plane TEID and the second control plane address.

In the embodiment of the present invention, optionally, the PDP context creation request message sent from the first sending unit 5205 and/or the RAB assignment request message sent from the second sending unit 5215 include a first request message, where the first request message is used to request creation of a control plane bearer between the HNB and the LGW.

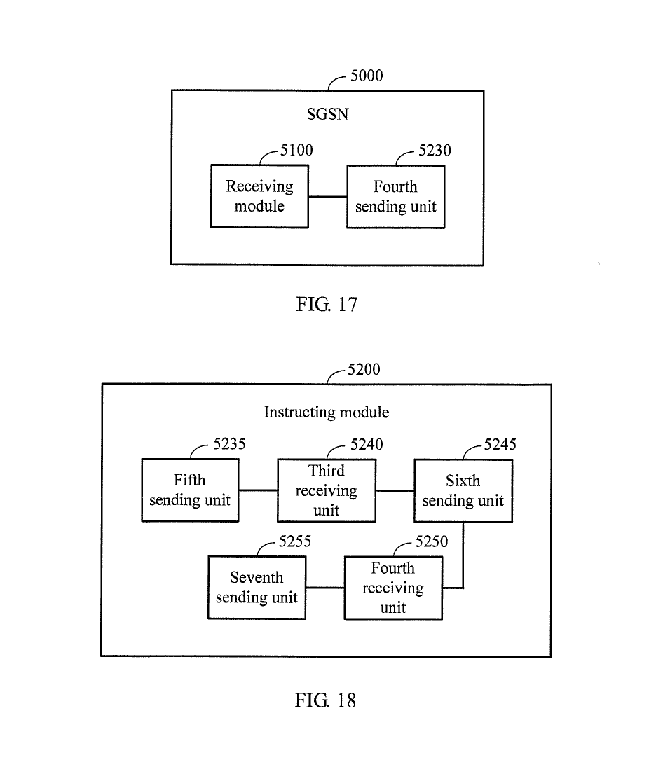

In the embodiment of the present invention, optionally, as shown in FIG. 17, the instructing module 5200 further includes:

a fourth sending unit 5230, configured to send a first bearer creation indication message to the HNB, where the first bearer creation indication message is used to instruct the HNB to create a control plane bearer between the HNB and the LGW, so that the HNB creates the control plane bearer with the LGW according to the first bearer creation indication message.

In the embodiment of the present invention, optionally, the first bearer creation indication message sent from the fourth sending unit 5230 includes at least one of a control plane address of the LGW in the local network and first indication information used to instruct the HNB to initiate creation of the control plane bearer.

In the embodiment of the present invention, optionally, as shown in FIG. 18, the instructing module 5200 further includes a fifth sending unit 5235, a third receiving unit 5240, a sixth sending unit 5245, a fourth receiving unit 5250, and a seventh sending unit 5255.

The fifth sending unit 5235 is configured to send a packet data protocol (PDP) context creation request message to the LGW.

The third receiving unit 5240 is configured to receive a PDP context creation response message sent from the LGW, where the PDP context creation response message carries a third control plane TEID and a third control plane address, and/or a first user plane TEID and a first user plane address, which are allocated by the LGW to the HNB GW.

The sixth sending unit 5245 is configured to send an RAB assignment request message to the HNB GW, where the RAB assignment request message carries the third control plane TEID and the third control plane address, and/or the first user plane TEID and the first user plane address.

The fourth receiving unit 5250 is configured to receive an RAB assignment response message sent from the HNB GW, where the RAB assignment response message carries a fourth control plane TEID and a fourth control plane address, and/or a second user plane TEID and a second user plane address, which are allocated by the HNB GW to the LGW.

The seventh sending unit 5255 is configured to send a PDP context update request message to the LGW, where the PDP context update request message carries the fourth control plane TEID and the fourth control plane address, and/or the second user plane TEID and the second user plane address.

In the embodiment of the present invention, optionally, the PDP context creation request message sent from the fifth sending unit 5235 and/or the RAB assignment request message sent from the sixth sending unit 5245 include a second request message, where the second request message is used to request creation of at least one control plane bearer and user plane bearer between the HNB GW and the LGW.

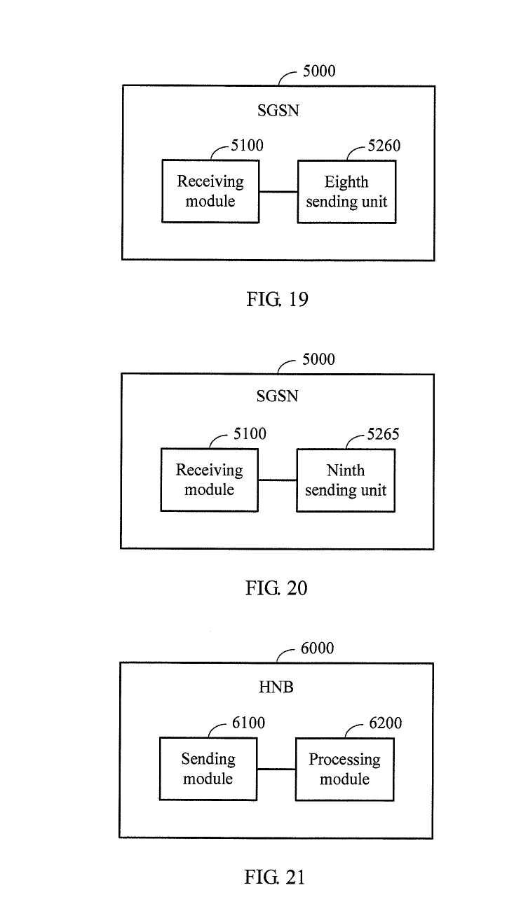

In the embodiment of the present invention, optionally, as shown in FIG. 19, the instructing module 5200 further includes:

an eighth sending unit 5260, configured to send a second bearer creation indication message to the HNB GW, where the second bearer creation indication message is used to instruct the HNB GW to create a bearer between the HNB GW and the LGW, so that the HNB GW creates at least one control plane bearer and user plane bearer with the LGW according to the second bearer creation indication message.

In the embodiment of the present invention, optionally, the second bearer creation indication message sent from the eighth sending unit 5260 includes at least one of local IP access LIPA bearer information, a control plane address of the LGW in a core network, a user plane address of the LGW in the core network, and second indication information used to instruct the HNB GW to initiate creation of the at least one control plane bearer and user plane bearer.

In the embodiment of the present invention, optionally, as shown in FIG. 20, the instructing module 5200 further includes:

a ninth sending unit 5265, configured to send a third bearer creation indication message to the LGW, where the third bearer creation indication message is used to instruct the LGW to create a bearer between the LGW and the HNB GW, so that the LGW creates at least one control plane bearer and user plane bearer with the HNB GW according to the third bearer creation indication message.

In the embodiment of the present invention, optionally, the third bearer creation indication message sent from the ninth sending unit 5265 includes at least one of a control plane address of the HNB GW in a core network, a user plane address of the HNB GW in a core network, and third indication information used to instruct the LGW to initiate creation of at least one control plane bearer and user plane bearer.

The SGSN 5000 according to the embodiment of the present invention may correspond to the SGSN in the embodiment of the present invention, and the foregoing and other operations and/or functions of each module in the SGSN 5000 are respectively intended for implementing corresponding procedures of each method in FIG. 1 to FIG. 8. For brevity, no repeated description is given here any further.

Therefore, the SGSN for creating a bearer in the embodiment of the present invention can implement creation of a bearer between an HNB or an HNB GW and an LGW, and prevent a user equipment (UE) from generating signaling exchanged with a core network in some scenarios, thereby saving signaling overhead and improving user experience.

FIG. 21 shows a schematic block diagram of an HNB 6000 according to an embodiment of the present invention. As shown in FIG. 21, the HNB 6000 includes a sending module 6100 and a processing module 6200.

The sending module 6100 is configured to send a bearer creation request message to a serving GPRS support node (SGSN), where the bearer creation request message is used to request creation of a bearer.

The processing module 6200 is configured to receive a bearer creation indication message sent from the SGSN according to the bearer creation request message sent from the sending module 6100, and create a bearer with a local gateway (LGW) according to the bearer creation indication message, where the bearer creation indication message is used to indicate creation of a bearer between the HNB and the LGW.

Therefore, the HNB for creating a bearer in the embodiment of the present invention can implement creation of a control plane bearer between an HNB and an LGW, and prevent a user equipment (UE) from generating signaling exchanged with a core network in some scenarios, thereby saving signaling overhead and improving user experience.

In the embodiment of the present invention, optionally, the bearer creation request message sent from the sending module 6100 includes at least one of an identifier of a local network on where the LGW is located, an address list of the LGW in a core network, and a first request message used to request creation of a control plane bearer between the HNB and the LGW.

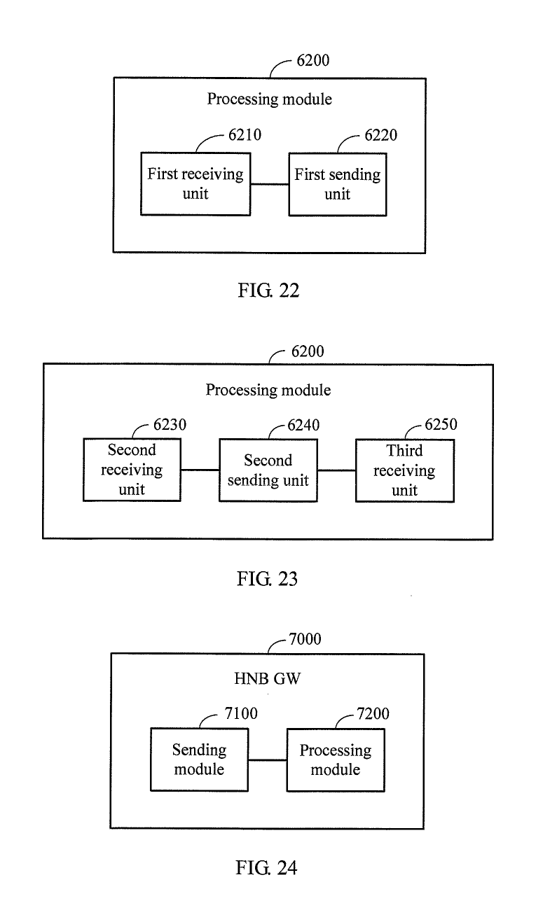

In the embodiment of the present invention, optionally, as shown in FIG. 22, the processing module 6200 includes a first receiving unit 6210 and a first sending unit 6220.

The first receiving unit 6210 is configured to receive a radio access bearer (RAB) assignment request message sent from the SGSN, where the RAB assignment request message includes a first control plane tunnel endpoint identifier (TEID) and a first control plane address that are allocated by the LGW to the HNB.

The first sending unit 6220 is configured to send an RAB assignment response message to the SGSN, where the RAB assignment response message carries a second control plane TEID and a second control plane address that are allocated by the HNB to the LGW, so that the SGSN sends the second control plane TEID and the second control plane address to the LGW by using a packet data protocol (PDP) context update request message.

In the embodiment of the present invention, optionally, as shown in FIG. 23, the processing module 6200 further includes a second receiving unit 6230, a second sending unit 6240, and a third receiving unit 6250.

The second receiving unit 6230 is configured to receive a first bearer creation indication message sent from the SGSN and used to instruct the HNB to create a control plane bearer between the HNB and the LGW.

The second sending unit 6240 is configured to: according to the first bearer creation indication message, send to the LGW a second control plane TEID and a second control plane address that are allocated by the HNB to the LGW.

The third receiving unit 6250 is configured to receive a first control plane TEID and a first control plane address that are sent from the LGW and allocated by the LGW to the HNB.

In the embodiment of the present invention, optionally, the first bearer creation indication message received by the second receiving unit 6230 includes at least one of a control plane address of the LGW in the local network and first indication information used to instruct the HNB to initiate creation of the control plane bearer.

The HNB 6000 according to the embodiment of the present invention may correspond to the HNB in the embodiment of the present invention, and the foregoing and other operations and/or functions of eachmodule in the HNB 6000 are respectively intended for implementing corresponding procedures of each method in FIG. 9 to FIG. 13. For brevity, no repeated description is given here any further.

Therefore, the HNB for creating a bearer in the embodiment of the present invention can implement creation of a control plane bearer between an HNB and an LGW, and prevent a user equipment (UE) from generating signaling exchanged with a core network in some scenarios, thereby saving signaling overhead and improving user experience.

FIG. 24 shows a schematic block diagram of an HNB GW 7000 according to an embodiment of the present invention. As shown in FIG. 24, the HNB GW 7000 includes a sending module 7100 and a processing module 7200.

The sending module 7100 is configured to send a bearer creation request message to a serving GPRS support node (SGSN), where the bearer creation request message is used to request creation of a bearer.

The processing module 7200 is configured to receive a bearer creation indication message sent from the SGSN according to the bearer creation request message sent from the sending module 7100, and create a bearer with a local gateway (LGW) according to the bearer creation indication message, where the bearer creation indication message is used to indicate creation of a bearer between the HNB GW and the LGW.

Therefore, the HNB GW for creating a bearer in the embodiment of the present invention can implement creation of at least one control plane bearer and user plane bearer between an HNB GW and an LGW, and prevent a user equipment (UE) from generating signaling exchanged with a core network in some scenarios, thereby saving signaling overhead and improving user experience.

In the embodiment of the present invention, optionally, the bearer creation request message sent from the sending module 7100 includes at least one of a control plane address of the HNB GW in a core network, a user plane address of the HNB GW in the core network, and a second request message used to request creation of at least one control plane bearer and user plane bearer between the HNB GW and the LGW.

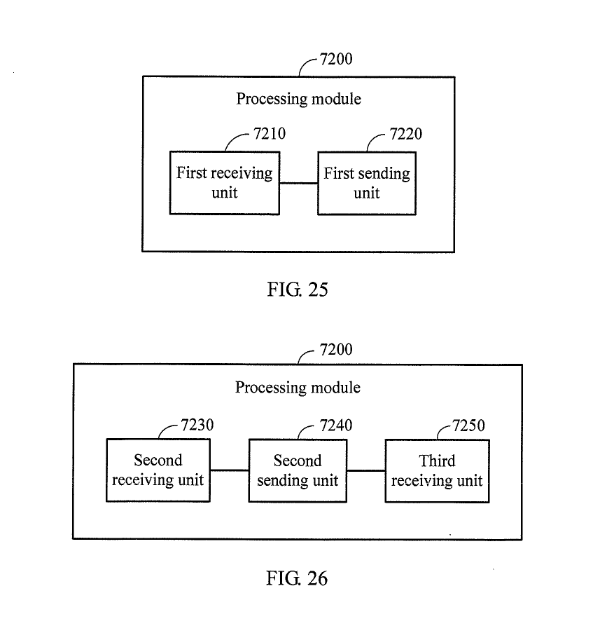

In the embodiment of the present invention, optionally, as shown in FIG. 25, the processing module 7200 includes a first receiving unit 7210 and a first sending unit 7220.

The first receiving unit 7210 is configured to receive a radio access bearer (RAB) assignment request message sent from the SGSN, where the RAB assignment request message includes a third control plane TEID and a third control plane address, and/or a first user plane TEID and a first user plane address, which are allocated by the LGW to the HNB GW.

The first sending unit 7220 is configured to send an RAB assignment response message to the SGSN, where the RAB assignment response message carries a fourth control plane TEID and a fourth control plane address, and/or a second user plane TEID and a second user plane address, which are allocated by the HNB GW to the LGW, so that the SGSN sends the fourth control plane TEID and the fourth control plane address, and/or the second user plane TEID and the second user plane address, to the LGW by using a packet data protocol (PDP) context update request message.

In the embodiment of the present invention, optionally, as shown in FIG. 26, the processing module 7200 further includes a second receiving unit 7230, a second sending unit 7240, and a third receiving unit 7250.

The second receiving unit 7230 is configured to receive a second bearer creation indication message sent from the SGSN and used to instruct the HNB GW to create a bearer between the HNB GW and the LGW.

The second sending unit 7240 is configured to: according to the second bearer creation indication message, send to the LGW a fourth control plane TEID and a fourth control plane address, and/or a second user plane TEID and a second user plane address, which are allocated by the HNB GW to the LGW.

The third receiving unit 7250 is configured to receive a third control plane TEID and a third control plane address, and/or a first user plane TEID and a first user plane address, which are sent from the LGW and allocated by the LGW to the HNB GW.

In the embodiment of the present invention, optionally, the second bearer creation indication message received by the second receiving unit 7230 includes at least one of local IP access LIPA bearer information, a control plane address of the LGW in a core network, a user plane address of the LGW in the core network, and second indication information used to instruct the HNB GW to initiate creation of the at least one control plane bearer and user plane bearer.

The HNB GW 7000 according to the embodiment of the present invention may correspond to the HNB GW in the embodiment of the present invention, and the foregoing and other operations and/or functions of each module in the HNB GW 7000 are respectively intended for implementing corresponding procedures of each method in FIG. 9 to FIG. 13. For brevity, no repeated description is given here any further.

Therefore, the HNB GW for creating a bearer in the embodiment of the present invention can implement creation of at least one control plane bearer and user plane bearer between an HNB GW and an LGW, and prevent a user equipment (UE) from generating signaling exchanged with a core network in some scenarios, thereby saving signaling overhead and improving user experience.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on the particular applications and design constraint conditions of the technical solution. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiments are merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and the parts displayed as units may or may not be physical units, may be located in one position, or may be distributed on a plurality of network units. Some or all of the units may be selected to achieve the objective of the solution of the embodiment of the present invention according to actual needs.

In addition, functional units in the embodiments of the present invention may be integrated into one processing unit, or each of the units may exist alone physically, or two or more units may be integrated into one unit. The integrated units may be implemented in a form of hardware, or may be implemented in a form of a software functional unit.

When the integrated units are implemented in a form of a software functional unit and sold or used as an independent product, the integrated units may be stored in a computer-readable storage medium. Based on such an understanding, the technical solutions of the present invention essentially, or the part contributing to the prior art, or all or a part of the technical solutions may be implemented in a form of a software product. The computer software product is stored in a storage medium and includes several instructions for instructing a computer device (which may be a personal computer, a server, or a network device) to perform all or a part of the steps of the methods described in the embodiments of the present invention. The foregoing storage medium includes: any mediums that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific embodiments of the present invention, but are not intended to limit the protection scope of the present invention. Any equivalent modification or replacement readily figured out by a person skilled in the art within the technical scope of the present invention shall fall within the protection scope of the present invention. Therefore, the protection scope of the present invention shall be subject to the protection scope of the claims.

What is claimed is:

1. A method for creating a bearer, the method comprising:
receiving a bearer creation request message sent from one of a home base station (HNB) and a home base station gateway (HNB GW) and used to request creation of a bearer; and
instructing the one of the HNB and the HNB GW to create a bearer with a local gateway (LGW) according to the bearer creation request message.

2. The method according to claim 1, wherein the bearer creation request message comprises at least one of an identifier of a local network on where the LGW is located, an address list of the LGW in a core network, and a first request message used to request creation of a control plane bearer between the HNB and the LGW.

3. The method according to claim 1, wherein instructing the one of the HNB and the HNB GW to create the bearer with the LGW comprises:
sending a packet data protocol (PDP) context creation request message to the LGW;
receiving a PDP context creation response message sent from the LGW, wherein the PDP context creation response message carries a first control plane tunnel endpoint identifier (TEID) and a first control plane address that are allocated by the LGW to the HNB;
sending a radio access bearer (RAB) assignment request message to the HNB, wherein the RAB assignment request message carries the first control plane TEID and the first control plane address;
receiving an RAB assignment response message sent from the HNB, wherein the RAB assignment response message carries a second control plane TEID and a second control plane address that are allocated by the HNB to the LGW; and
sending a PDP context update request message to the LGW, wherein the PDP context update request message carries the second control plane TEID and the second control plane address.

4. The method according to claim 3, wherein at least one of the PDP context creation request message and the RAB assignment request message comprise a first request message used to request creation of a control plane bearer between the HNB and the LGW.

5. The method according to claim 1, wherein instructing the one of the HNB and the HNB GW to create the bearer with the LGW comprises:
sending a first bearer creation indication message to the HNB, wherein the first bearer creation indication message is used to instruct the HNB to create a control plane bearer between the HNB and the LGW, so that the HNB creates the control plane bearer with the LGW according to the first bearer creation indication message.

6. The method according to claim 5, wherein the first bearer creation indication message comprises at least one of a control plane address of the LGW in the local network and first indication information used to instruct the HNB to initiate creation of the control plane bearer.

7. The method according to claim 1, wherein the bearer creation request message comprises at least one of a control plane address of the HNB GW in a core network, a user plane address of the HNB GW in the core network, and a second request message used to request creation of at least one control plane bearer and user plane bearer between the HNB GW and the LGW.

8. The method according to claim 1, wherein instructing the one of the HNB and the HNB GW to create the bearer with the LGW comprises:
sending a packet data protocol (PDP) context creation request message to the LGW;
receiving a PDP context creation response message sent from the LGW, wherein the PDP context creation response message carries a third control plane TEID and a third control plane address, and/or a first user plane TEID and a first user plane address, which are allocated by the LGW to the HNB GW;
sending an RAB assignment request message to the HNB GW, wherein the RAB assignment request message carries the third control plane TEID and the third control plane address, and/or the first user plane TEID and the first user plane address;
receiving an RAB assignment response message sent from the HNB GW, wherein the RAB assignment response message carries a fourth control plane TEID and a fourth control plane address, and/or a second user plane TEID and a second user plane address, which are allocated by the HNB GW to the LGW; and
sending a PDP context update request message to the LGW, wherein the PDP context update request message carries the fourth control plane TEID and the fourth control plane address, and/or the second user plane TEID and the second user plane address.

9. The method according to claim 8, wherein at least one of the PDP context creation request message and the RAB assignment request message comprise a second request message used to request creation of at least one control plane bearer and user plane bearer between the HNB GW and the LGW.

10. The method according to claim 1, wherein instructing the one of the HNB and the HNB GW to create the bearer with the LGW comprises:
sending a second bearer creation indication message to the HNB GW, wherein the second bearer creation indication message is used to instruct the HNB GW to create a bearer between the HNB GW and the LGW, so that the HNB GW creates at least one control plane bearer and user plane bearer with the LGW according to the second bearer creation indication message.

11. The method according to claim 10, wherein the second bearer creation indication message comprises at least one of local IP access (LIPA) bearer information, a control plane address of the LGW in a core network, a user plane address of the LGW in the core network, and second indication information used to instruct the HNB GW to initiate creation of the at least one control plane bearer and user plane bearer.

12. The method according to claim 1, wherein instructing the one of the HNB and the HNB GW to create the bearer with the LGW comprises:
sending a third bearer creation indication message to the LGW, wherein the third bearer creation indication message is used to instruct the LGW to create a bearer between the LGW and the HNB GW, so that the LGW creates at least one control plane bearer and user plane bearer with the HNB GW according to the third bearer creation indication message.

13. The method according to claim 12, wherein the third bearer creation indication message comprises at least one of a control plane address of the HNB GW in a core network, a user plane address of the HNB GW in the core network, and third indication information used to instruct the LGW to initiate creation of at least one control plane bearer and user plane bearer.

14. A method for creating a bearer, the method comprising:
sending a bearer creation request message to a serving GPRS support node (SGSN), wherein the bearer creation request message is used to request creation of a bearer; and
receiving a bearer creation indication message sent from the SGSN according to the bearer creation request message, and creating a bearer with a local gateway (LGW) according to the bearer creation indication message, wherein the bearer creation indication message is used to indicate creation of a bearer between an HNB or an HNB GW and the LGW.

15. The method according to claim 14, wherein the bearer creation request message comprises at least one of an identifier of a local network on where the LGW is located, an address list of the LGW in a core network, and first request message used to request creation of a control plane bearer between the HNB and the LGW.

16. The method according to claim 14, wherein receiving a bearer creation indication message sent from the SGSN according to the bearer creation request message, and creating a bearer with a local gateway (LGW) according to the bearer creation indication message, comprise:
receiving a radio access bearer (RAB) assignment request message sent from the SGSN, wherein the RAB assignment request message comprises a first control plane tunnel endpoint identifier (TEID) and a first control plane address that are allocated by the LGW to the HNB; and
sending an RAB assignment response message to the SGSN, wherein the RAB assignment response message carries a second control plane TEID and a second control plane address that are allocated by the HNB to the LGW, so that the SGSN sends the second control plane TEID and the second control plane address to the LGW by using a packet data protocol (PDP) context update request message.

17. The method according to claim 14, wherein receiving a bearer creation indication message sent from the SGSN according to the bearer creation request message, and creating a bearer with a local gateway (LGW) according to the bearer creation indication message, comprise:
receiving a first bearer creation indication message sent from the SGSN and used to instruct the HNB to create a control plane bearer between the HNB and the LGW;
according to the first bearer creation indication message, sending to the LGW a second control plane TEID and a second control plane address that are allocated by the HNB to the LGW; and
receiving a first control plane TEID and a first control plane address that are sent from the LGW and allocated by the LGW to the HNB.

18. The method according to claim 17, wherein the first bearer creation indication message comprises at least one of a control plane address of the LGW in the local network and first indication information used to instruct the HNB to initiate creation of the control plane bearer.

19. The method according to claim 14, wherein the bearer creation request message comprises at least one of a control plane address of the HNB GW in a core network, a user plane address of the HNB GW in the core network, and a second request message used to request creation of at least one control plane bearer and user plane bearer between the HNB GW and the LGW.

20. The method according to claim 14, wherein receiving a bearer creation indication message sent from the SGSN according to the bearer creation request message, and creating a bearer with a local gateway (LGW) according to the bearer creation indication message, comprise:
receiving a radio access bearer (RAB) assignment request message sent from the SGSN, wherein the RAB assignment request message comprises a third control plane TEID and a third control plane address, and/or a first user plane TEID and a first user plane address, which are allocated by the LGW to the HNB GW; and
sending an RAB assignment response message to the SGSN, wherein the RAB assignment response message carries a fourth control plane TEID and a fourth control plane address, and/or a second user plane TEID and a second user plane address, which are allocated by the HNB GW to the LGW, so that the SGSN sends the fourth control plane TEID and the fourth control plane address, and/or the second user plane TEID and the second user plane address, to the LGW by using a packet data protocol (PDP) context update request message.

21. The method according to claim 14, wherein receiving a bearer creation indication message sent from the SGSN according to the bearer creation request message, and creating a bearer with a local gateway (LGW) according to the bearer creation indication message, comprise:
receiving a second bearer creation indication message sent from the SGSN and used to instruct the HNB GW to create a bearer between the HNB GW and the LGW;
according to the second bearer creation indication message, sending to the LGW a fourth control plane TEID and a fourth control plane address, and/or a second user plane TEID and a second user plane address, which are allocated by the HNB GW to the LGW; and
receiving a third control plane TEID and a third control plane address, and/or a first user plane TEID and a first user plane address, which are sent from the LGW and allocated by the LGW to the HNB GW.

22. The method according to claim 21, wherein the second bearer creation indication message comprises at least one of local IP access (LIPA) bearer information, a control plane address of the LGW in a core network, a user plane address of the LGW in the core network, and second indication information used to instruct the HNB GW to initiate creation of the at least one control plane bearer and user plane bearer.

23. A serving GPRS support node (SGSN), comprising:
a receiver, configured to receive a bearer creation request message sent from a home base station (HNB) or a home base station gateway (HNB GW) and used to request creation of a bearer; and
a transmitter configured to transmit an instruction for instructing the one of the HNB and the HNB GW to create a bearer with a local gateway (LGW) according to the bearer creation request message.

24. The SGSN according to claim 23, wherein the bearer creation request message comprises at least one of an identifier of a local network on where the LGW is located, an address list of the LGW in a core network, and a first request message used to request creation of a control plane bearer between the HNB and the LGW.

25. The SGSN according to claim 23, wherein:
the transmitter is further configured to sendapacket data protocol (PDP) context creation request message to the LGW;
the receiver is further configured to receive a PDP context creation response message sent from the LGW, wherein the PDP context creation response message carries a first control plane tunnel endpoint identifier (TEID) and a first control plane address that are allocated by the LGW to the HNB;
the transmitter is further configured to send a radio access bearer (RAB) assignment request message to the HNB, wherein the RAB assignment request message carries the first control plane TEID and the first control plane address;
the receiver is further configured to receive an RAB assignment response message sent from the HNB, wherein the RAB assignment response message carries a second control plane TEID and a second control plane address that are allocated by the HNB to the LGW; and
the transmitter is further configured to send a PDP context update request message to the LGW, wherein the PDP context update request message carries the second control plane TEID and the second control plane address.

26. The SGSN according to claim 25, wherein the PDP context creation request message and/or the RAB assignment request message comprise a first request message used to request creation of a control plane bearer between the HNB and the LGW.

27. The SGSN according to claim 23, wherein the transmitter is further configured to send a first bearer creation indication message to the HNB, wherein the first bearer creation indication message is used to instruct the HNB to create a control plane bearer between the HNB and the LGW, so that the HNB creates the control plane bearer with the LGW according to the first bearer creation indication message.

28. The SGSN according to claim 27, wherein the first bearer creation indication message comprises at least one of a control plane address of the LGW in the local network and first indication information used to instruct the HNB to initiate creation of the control plane bearer.

29. The SGSN according to claim 23, wherein the bearer creation request message comprises at least one of a control plane address of the HNB GW in a core network, a user plane address of the HNB GW in the core network, and a second request message used to request creation of at least one control plane bearer and user plane bearer between the HNB GW and the LGW.

30. The SGSN according to claim 23, wherein:
the transmitter is further configured to send a packet data protocol (PDP) context creation request message to the LGW;
the receiver is further configured to receive apacket data protocol (PDP) context creation response message sent from the LGW, wherein the PDP context creation response message carries a third control plane TEID and a third control plane address, and/or a first user plane TEID and a first user plane address, which are allocated by the LGW to the HNB GW;
the transmitter is further configured to send an RAB assignment request message to the HNB GW, wherein the RAB assignment request message carries the third control plane TEID and the third control plane address, and/or the first user plane TEID and the first user plane address;
the receiver is further configured to receive an RAB assignment response message sent from the HNB GW, wherein the RAB assignment response message carries a fourth control plane TEID and a fourth control plane address, and/or a second user plane TEID and a second user plane address, which are allocated by the HNB GW to the LGW; and
the transmitter is further configured to send a packet data protocol (PDP) context update request message to the LGW, wherein the PDP context update request message carries the fourth control plane TEID and the fourth control plane address, and/or the second user plane TEID and the second user plane address.

31. The SGSN according to claim 30, wherein the PDP context creation request message and/or the RAB assignment request message comprise a second request message used to request creation of at least one control plane bearer and user plane bearer between the HNB GW and the LGW.

32. The SGSN according to claim 23, wherein the transmitter is further configured to send a second bearer creation indication message to the HNB GW, wherein the second bearer creation indication message is used to instruct the HNB GW to create a bearer between the HNB GW and the LGW, so that the HNB GW creates at least one control plane bearer and user plane bearer with the LGW according to the second bearer creation indication message.

33. The SGSN according to claim 32, wherein the second bearer creation indication message comprises at least one of local IP access (LIPA) bearer information, a control plane address of the LGW in a core network, a user plane address of the LGW in the core network, and second indication information used to instruct the HNB GW to initiate creation of the at least one control plane bearer and user plane bearer.

34. The SGSN according to claim 23, wherein the transmitter is further configured to send a third bearer creation indication message to the LGW, wherein the third bearer creation indication message is used to instruct the LGW to create a bearer between the LGW and the HNB GW, so that the LGW creates at least one control plane bearer and user plane bearer with the HNB GW according to the third bearer creation indication message.

35. The SGSN according to claim 34, wherein the third bearercreation indication message comprises at least one of a control plane address of the HNB GW in a core network, a user plane address of the HNB GW in the core network, and third indication information used to instruct the LGW to initiate creation of at least one control plane bearer and user plane bearer.

36. A home base station (HNB), comprising:
a transmitter, configured to send a bearer creation request message to a serving GPRS support node (SGSN), wherein the bearer creation request message is used to request creation of a bearer; and
a receiver, configured to receive a bearer creation indication message sent from the SGSN according to the bearer creation request message, wherein the bearer creation indication message is used to indicate creation of a bearer between the HNB and a local gateway (LGW); and
a processor, configured to create the bearer with the LGW according to the bearer creation indication message.

37. The HNB according to claim 36, wherein the bearer creation request message comprises at least one of an identifier of a local network on where the LGW is located, an address list of the LGW in a core network, and a first request message used to request creation of a control plane bearer between the HNB and the LGW.

38. The HNB according to claim 36, wherein:
the receiver is further configured to receive a radio access bearer (RAB) assignment request message sent from the SGSN, wherein the RAB assignment request message comprises a first control plane tunnel endpoint identifier (TEID) and a first control plane address that are allocated by the LGW to the HNB; and
the transmitter is further configured to send an RAB assignment response message to the SGSN, wherein the RAB assignment response message carries a second control plane TEID and a second control plane address that are allocated by the HNB to the LGW, so that the SGSN sends the second control plane TEID and the second control plane address to the LGW by using a packet data protocol (PDP) context update request message.

39. The HNB according to claim 36, wherein:
the receiver is further configured to receive a first bearer creation indication message sent from the SGSN and used to instruct the HNB to create a control plane bearer between the HNB and the LGW;
the transmitter is further configured to send a second control plane TEID and a second control plane address that are allocated by the HNB to the LGW to the LGW according to the first bearer creation indication message; and
the receiver is further configured to receive a first control plane TEID and a first control plane address that are sent from the LGW and allocated by the LGW to the HNB.

40. The HNB according to claim 39, wherein the first bearer creation indication message comprises at least one of a control plane address of the LGW in the local network and first indication information used to instruct the HNB to initiate creation of the control plane bearer.

41. A home base station gateway (HNB GW), comprising:
a transmitter, configured to send a bearer creation request message to a serving GPRS support node (SGSN), wherein the bearer creation request message is used to request creation of a bearer; and
a receiver, configured to receive a bearer creation indication message sent from the SGSN according to the bearer creation request message sent from the sending module, wherein the bearer creation indication message is used to indicate creation of a bearer between an HNB GW and a local gateway (LGW); and
a processor, configured to create the bearer with the LGW according to the bearer creation indication message.

42. The HNB GW according to claim 41, wherein the bearer creation request message comprises at least one of a control plane address of the HNB GW in a core network, a user plane address of the HNB GW in the core network, and a second request message used to request creation of at least one control plane bearer and user plane bearer between the HNB GW and the LGW.

43. The HNB GW according to claim 41, wherein:
the receiver is further configured to receive a radio access bearer (RAB) assignment request message sent from the SGSN, wherein the RAE assignment request message comprises a third control plane TEID and a third control plane address, and/or a first user plane TEID and a first user plane address, which are allocated by the LGW to the HNB GW; and
the transmitter is further configured to send an RAB assignment response message to the SGSN, wherein the RAB assignment response message carries a fourth control plane TEID and a fourth control plane address, and/or a second user plane TEID and a second user plane address, which are allocated by the HNB GW to the LGW, so that the SGSN sends the fourth control plane TEID and the fourth control plane address, and/or the second user plane TEID and the second user plane address, to the LGW by using a packet data protocol (PDP) context update request message.

44. The HNB GW according to claim 41, wherein:
the receiver is further configured to receive a second bearer creation indication message sent from the SGSN and used to instruct the HNB GW to create a bearer between the HNB GW and the LGW;
the transmitter is further configured to: according to the second bearer creation indication message, send to the LGW a fourth control plane TEID and a fourth control plane address, and/or a second user plane TEID and a second user plane address, which are allocated by the HNB GW to the LGW; and
the receiver is further configured to receive a third control plane TEID and a third control plane address, and/or a first user plane TEID and a first user plane address, which are sent from the LGW and allocated by the LGW to the HNB GW.

45. The HNB GW according to claim 44, wherein the second bearer creation indication message comprises at least one of local IP access (LIPA) bearer information, a control plane address of the LGW in a core network, a user plane address of the LGW in the core network, and second indication information used to instruct the HNB GW to initiate creation of the at least one control plane bearer and user plane bearer.
